(19) United States
(12) Patent Application Publication
(10) Pub. No.: US 2012/0168460 A1
(43) Pub. Date: Jul. 5, 2012

(54) REUSABLE DISPENSING VALVE FOR PRESSURIZED CANISTERS

(76) Inventor: Boris Tolstykh, Aurora, OH (US)

(21) Appl. No.: 12/981,701

(22) Filed: Dec. 30, 2010

(51) Int. Cl. B67D 1/00; B65D 83/00

(52) U.S. Cl. 222/83; 222/402.1

(57) ABSTRACT

A pressurized canister with a reusable dispensing valve is provided. A metallic canister is provided with a threaded throat that is adapted to threadedly receive a valve assembly. An insert within the throat maintains a seal, for sealing the pressurized canister, and a membrane that is adapted to be pierced by a dispensing valve. This dispensing valve is spring biased and is movable within a pair of bores within the valve assembly. An outlet needle has an L-shaped passage that constitutes a portion of the valve such that movement of the valve inwardly not only pierces the membrane, but allows a radial leg of the L-shaped passage to communicate with the interior of the canister and dispense the pressurized gas therefrom. When the gas has all been dispensed, the valve assembly may be threadedly disengaged from the canister throat and reused upon threaded engagement with a new or refilled cansister.

### TECHNICAL FIELD

The invention herein resides in the art of valves for pressurized canisters and, more particularly, to green gas canisters. Particularly, the invention relates to valved canisters of the type containing pressurized gas to be used as propellant for any of various purposes, such as in air soft guns and the like. Specifically, the invention relates to a removable, replaceable and reusable dispensing valve for use in such pressurized canisters.

### BACKGROUND ART

The use of green gas canisters for maintaining and dispensing propellants and the like is now commonly known. Indeed, green gas propellants are commonly used with the sporting goods of air soft guns and the like. Green gas is maintained within the canister or cylinder and dispensed therefrom through a valve, as needed. In the past, such canisters have typically been of an 8 oz. size, and have generally consisted of a metal canister having an integral valve for selective release of the green gas. Indeed, the integral valve has typically been the most costly part of the canister and valve system.

Presently, shipping restrictions preclude the shipment of such pressurized containers in volumes that are greater than 4 oz. Accordingly, the size of the canister must now be reduced by 50 percent. However, with the integral valve being the most costly portion of the canister and valve combination, reducing the size of the canister to 4 oz., while maintaining an integral valve, greatly increases the cost per ounce of the gas contained therein.

The art is confronted with the need for a 4 oz. pressurized green gas canister with an associated dispensing valve, and which can be implemented without increasing the effective cost per ounce of gas over the previously employed 8 oz. canister/valve assemblies. Indeed, there is a need in the art for a 4 oz. pressurized green gas canister with a removable, replaceable, and reusable dispensing valve.

### DISCLOSURE OF INVENTION

In light of the foregoing, it is a first aspect of the invention to provide a 4 oz. canister of pressurized green gas.

Another aspect of the invention is the provision of a 4 oz. pressurized green gas canister with a removable, replaceable and reusable dispensing valve.

Another aspect of the invention is the provision of a 4 oz. pressurized green gas canister which is sealed by a membrane that may be pierced by a dispensing needle of a removable, replaceable and reusable dispensing valve.

Yet a further aspect of the invention is the provision of a 4 oz. pressurized green gas canister having a removable, replaceable and reusable dispensing valve that serves to seal the canister and maintain it in a sealed condition following piercing of a membrane.

Yet an additional aspect of the invention is the provision of a 4 oz. pressurized green gas canister having a removable, replaceable and reusable dispensing valve, which is constructed with available technology and adapted for use in replacing previously know 8 oz. canisters.

The foregoing and other aspect of the invention that will become apparent as the detailed description proceeds are achieved by a canister and valve assembly for maintaining and dispensing pressurized gas, comprising: a canister having a throat extending axially from an end thereof; a valve assembly threadedly attached to said throat; a pair of seals interposed between said valve assembly and said throat; and a membrane sealingly interposed between said valve assembly and said throat.

Additional aspects fo the invention that will become apparent herein are attained by a canister and valve assembly for maintaining and dispensing pressurized gas, comprising: a canister; a threaded throat extending axially from said canister, said throat having a flange extending radially inward at an end thereof; a valve assembly threadedly secured to said throat; an insert received within said throat; a seal ring interposed between said insert and said flange; an annular seal interposed between said flange and said valve assembly; and a spring-biased needle comprising a portion of said valve assembly, said needle having an outlet movable between sealed and exhaust positions.

### DESCRIPTION OF DRAWING

For a complete understanding of the various aspects, structures and operation of the invention, reference should be made to the following detailed description and accompanying drawing wherein:

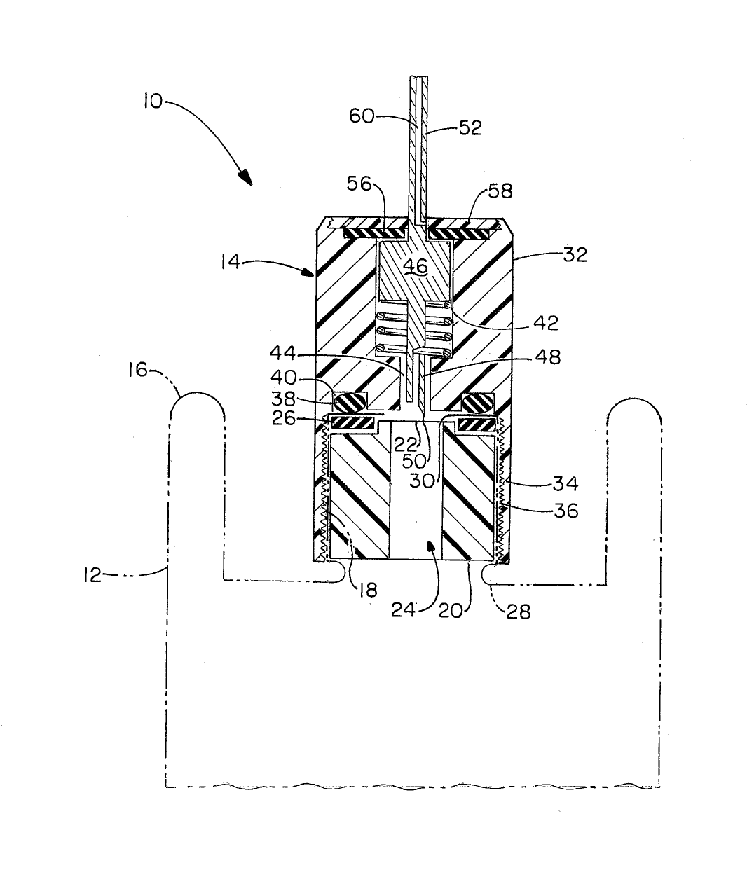

The single drawing FIG. 1 is an illustrative cross-sectional depiction of a pressurized canister with a reusable dispensing valve made in accordance with the invention.

### BEST MODE FOR CARRYING OUT THE INVENTION

Referring now to the drawing it can be seen that a canister and valve assembly made in accordance with the invention is designated generally by the numeral 10. The assembly 10 includes a canister 12, typically of metallic construction, and which may be conventionally formed by rolling or the like. The canister 12 receives a valve assembly 14, the details of which will be presented later herein. A cap ring 16 encircles a top portion of the canister 12 and is configured to sealingly receive a protective cap or cover (not shown), which fits thereover.

Extending axially from an end of canister 12 is a cylindrical throat 18, which receives and maintains a cylindrical insert 20, formed from an appropriate plastic or the like. The cylindrical insert 20 has a membrane 22 extending across an upper end thereof and sealing the axial bore 24 of the insert 20. A rubber seal ring 26 is maintained upon a shoulder of the cylindrical insert 20. An annular rim 28 at the base of the throat 18 supports the insert 20, while an annular flange 30, extending inwardly from the throat 18, captures the top of the cylindrical insert 20 and a rubber seal ring 26. It will be appreciated that the rubber seal ring 26 is sandwiched between the annular flange 30 and the shoulder of the cylindrical insert 20 as by force imparted in part by the annular rim 28.

The valve assembly 14 includes a valve body 32 having a cup-shaped end 34 at one end thereof. The cup-shaped end 34 has interior threads thereabout, while the canister throat 18 has mating exterior threads thereabout. Accordingly, the valve assembly 14 may be threaded upon the throat 18 of the canister 12 by means of the mating thread at 36.

An annular rubber seal 38 is maintained within an annular cavity 40 of the valve body 32, as shown. It will be appreciated that as the valve body 32 is threaded upon the threaded throat 18, the seal 38 compresses and seals between the annular flange 30 and the valve body 32, and further compresses the annular flange 30 against the rubber seal ring 26 to ensure that sealing engagement, as well.

The valve body 32 is characterized by a first larger bore 42 and a second smaller bore 44, interconnected with each other and both coaxial with and interconnecting the bore 24 of the cylindrical insert 20.

The bores 42, 44 receive a needle assembly, comprising a needle body 46 in the bore 42 and a needle core 48 within the bore 44. A sharp piercing tip 50 is provided at the end of the needle core 48, as shown. A needle outlet 52 is provided as it extends from the needle body 46 in a direction opposite the needle core 48.

A compression spring 54 is received within the cavity 42 at an end thereof opposite the end receiving the needle body 46. The spring 54 urges the needle body 46 upwardly as shown in the drawing.

A rubber seal 56 is provided at a top end of body 32 and is retained in place by an appropriate retainer 58. The seal 56 seals against any leakage that might occur about the stem or needle outlet 52.

As shown in the drawing, an L-shaped passage 60 extends through the needle outlet 52, traveling the length of the needle outlet 52 in an axial direction and then exiting the wall thereof in a radial direction.

With an understanding of the structure presented and described above, the use and operation will now be attended. With a cap (not shown) removed from the cap ring 16, the canister 12 with affixed valve assembly 14, may be placed in a device or otherwise manipulated in such a manner that the needle outlet 52 is depressed or pushed inwardly into the valve body 32, causing the needle body 46 to move in the large bore 42 to move against the spring 54 and project the needle core 48 axially along the bore 44, ultimately causing the pointed sharp piercing tip 50 to pierce or break the membrane 22. At such time, the radial extending portion of the L-shaped passage 60 is within the bore 42, such that the pressurized green gas within the container 12 passes through the bore 24, broken membrane 22, bore 44, large bore 42, and out the L-shaped passage 52 for use as an propellant in a device receiving the assembly 10 or otherwise. When the force depressing the needle outlet 50 is released, the spring 54 urges the needle body 46 upwardly, such that the radial extension of the L-shaped passage 62 is no longer within the bore 42, terminating dispensing.

As presented above, it is contemplated that the canister 12 will hold 4 oz. of green gas, and when those 4 oz. are spent, the valve assembly 14 may be removed from the canister 12 by unthreading the threaded engagement at 56. The canister 12 may then be discarded or recycled, and the valve assembly 14 applied to a new or refilled canister.

Thus it can be seen that the various aspects of the invention have been satisfied by the structure and techniques described above. While in accordance with the patent statutes only the best mode and preferred embodiment of the invention has been presented and described in detail, it will be understood that the invention is not limited thereto or thereby. Accordingly, for an appreciation of the true scope and breadth of the invention, reference should be made to the following claims.

What is claimed is:

1. A canister and valve assembly for maintaining and dispensing pressurized gas, comprising:
a canister having a throat extending axially from an end thereof;
a valve assembly threadedly attached to said throat;
a pair of seals interposed between said valve assembly and said throat; and
a membrane sealingly interposed between said valve assembly and said throat.

2. The canister and valve assembly for maintaining and dispensing pressurized gas according to claim 1, wherein said throat has an annular flange extending between said pair of seals.

3. The canister and valve assembly for maintaining and dispensing pressurized gas according to claim 2, further comprising an insert received within said throat and engaging a first seal of said pair of seals.

4. The canister and valve assembly for maintaining and dispensing pressurized gas according to claim 3, wherein said first seal comprises a seal ring interposed between said insert and said annular flange.

5. The canister and valve assembly for maintaining and dispensing pressurized gas according to claim 4, wherein a second seal of said pair of seals comprises an annular seal interposed between said annular flange and a body of said valve assembly.

6. The canister and valve assembly for maintaining and dispensing pressurized gas according to claim 5, wherein said threadedly attached relationship between said valve assembly and said throat comprises said annular seal to effect a seal between said throat and said body of said valve assembly.

7. The canister and valve assembly for maintaining and dispensing pressurized gas according to claim 1, wherein said valve assembly comprises a body having a spring-biased needle movably retained thereby.

8. The canister and valve assembly for maintaining and dispensing pressurized gas according to claim 7, wherein said needle has a core with a piercing point in juxtaposition to said membrane, and movable within a first bore.

9. The canister and valve assembly for maintaining and dispensing pressurized gas according to claim 8, wherein said needle further comprises a body connected to said core and in engagement with a spring within a second bore, said first and second bores in communication with each other and, upon piercing of said membrane, in communication with an interior of said canister.

10. The canister and valve assembly for maintaining and dispensing pressurized gas according to claim 9, wherein said needle further comprises a needle outlet having an L-shaped passage, said needle outlet connected to said needle body, a radial portion of said L-shaped passage being in selective communication with said second bore.

11. A canister and valve assembly for maintaining and dispensing pressurized gas, comprising:
a canister;
a threaded throat extending axially from said canister, said throat having a flange extending radially inward at an end thereof;
a valve assembly threadedly secured to said throat;
an insert received within said throat;
a seal ring interposed between said insert and said flange;
an annular seal interposed between said flange and said valve assembly; and
a spring-biased needle comprising a portion of said valve assembly, said needle having an outlet movable between sealed and exhaust positions.

12. The canister and valve assembly according to claim 11, wherein said insert is cylindrical and has a membrane sealing an end thereof.

13. The canister and valve assembly according to claim 12, wherein said spring biased needle has a piercing point in juxtaposition with said membrane.

14. The canister and valve assembly according to claim 13, wherein said needle has an outlet passage that is L-shaped, and which is selectively positionable between said sealed and exhaust positions.
